(19) United States
(12) Patent Application Publication
(10) Pub. No.: US 2022/0092392 A1
(43) Pub. Date: Mar. 24, 2022

(54) Audio Representation for Variational Auto-encoding

(71) Applicant: AiMi Inc., Littleton, CO (US)

(72) Inventor: Toby Gifford, Melbourne (AU)

(21) Appl. No.: 17/476,952

(22) Filed: Sep. 16, 2021

Related U.S. Application Data
(60) Provisional application No. 63/080,615, filed on Sep. 18, 2020.

(51) Int. Cl. G06N 3/04; G06N 3/08

(52) U.S. Cl. CPC G06N 3/0472; G06N 3/08; G06N 3/0454

(57) ABSTRACT

Various methods for representing audio suitable for use in variational audio encoding are disclosed. A method comprises maintaining, by a computing system, state information for multiple resonator models with different resonant frequencies. The method further comprises iteratively performing a number of different operations, by the computing system for multiple respective samples in a set of audio samples in the time domain. These operations include updating the state information for the multiple resonator models based on the sample amplitude. The operations also include determining respective resonator amplitudes and phases for the updated multiple resonator models and storing, respective resonator amplitude and change-in-phase information for the sample.

### PRIORITY CLAIM

The present application claims priority to U.S. Prov. Appl. No. 63/080,615, filed Sep. 18, 2020, which is incorporated by reference herein in its entirety.

### BACKGROUND

### Technical Field

This disclosure is directed to signal processing, and more particularly, the encoding and processing of audio signals.

### Description of the Related Art

Variational Auto Encoders (VAEs) provide a means to morph between different audio using deep learning, with applications in generative music production and automated remixing. The practical application of this method is complicated by the audio representation used. For musical results, training is often performed in the frequency domain, for example, using a Fast Fourier Transform (FFT). Resynthesis of audio signals may be accomplished using an inverse FFT, in those implementations.

### SUMMARY

Various methods for representing audio suitable for use in variational audio encoding are disclosed. In one embodiment, a method comprises maintaining, by a computing system, state information for multiple resonator models with different resonant frequencies. The method further comprises iteratively performing a number of different operations, by the computing system for multiple respective samples in a set of audio samples in the time domain. These operations include updating the state information for the multiple resonator models based on the sample amplitude. The operations also include determining respective resonator amplitudes and phases for the updated multiple resonator models and storing, respective resonator amplitude and change-in-phase information for the sample.

Various embodiments in which the audio samples are resynthesized into an audio signal are possible and contemplated. Such embodiments may also include pitch shifting the audio signal. This may be accomplished by determining a phase increment and pitch shifting the various samples a product of the phase increment and some multiplier value. The embodiments further contemplate combining the resynthesized audio signal with one or more additional audio signals (which may or may not be resynthesized signals from the method disclosed herein). The recombining may be done automatically to generate a musical composition.

### BRIEF DESCRIPTION OF THE DRAWINGS

The following detailed description makes reference to the accompanying drawings, which are now briefly described.

FIG. 1 is a diagram illustrating one embodiment of a methodology for sampling a signal and updating resonator models accordingly.

FIG. 2 is a diagram illustrating one embodiment of a chain of resonators, illustrating the chain in an initial state and an excited state.

FIG. 3 is a flow diagram of one embodiment of a method for determining position, velocity, and acceleration of resonators for a number of audio samples.

FIG. 4 is a flow diagram of one embodiment of a method for determining an amplitude and a phase shift increment for a number of audio samples.

FIG. 5 is a flow diagram of one embodiment of a method for sampling a signal and updating resonator models accordingly.

FIG. 6 is a diagram illustrating one embodiment of a data structure having amplitude and phase shift information for a number of different resonators over a number of audio samples.

FIG. 7 is a block diagram illustrating one embodiment of a system for generating a musical composition using encoded audio files.

FIG. 8 is a block diagram illustrating one embodiment of a computing device capable of carrying out the encoding and music generation applications disclosed herein.

### DETAILED DESCRIPTION OF EMBODIMENTS

Variational Auto Encoders (VAEs) provide a mechanism to morph between different audio using deep learning, with applications in generative music production and automated remixing. The practical application of this method is complicated by the audio representation used. For musical results, the training may best be performed in the frequency domain. In many cases, however, resynthesizing arbitrary Fast Fourier Transform (FFT) data results in low quality audio, akin to low bitrate audio files that lack fidelity with respect to the original audio. Generally speaking, neither time domain nor frequency domain representations are sufficient to capture the information to enable representation of sound as perceived by the human ear.

One challenge in training a VAE using pure FFT data is that the topology of the phase is lost. The phase of a signal is periodic, but it unknown to the VAE unless specifically modeled. Even when the phase is modeled, audio resulting from FFT resynthesis may be adversely affected by an inability to properly represent a constantly unwinding phase.

The present disclosure is directed to a time-frequency representation of audio that is suited for resynthesis from a VAE. The various methodologies disclosed herein may generate the time-frequency representation of audio on a sample-by-sample basis that omits windowing. The methodologies may further respect the topology of phase-space within sampled audio signal. Furthermore, the present disclosure allows for pitch-shifting of audio signals on resynthesis, the combining of resynthesized audio signals, and the automatic generation of musical compositions using the combined audio signals.

In some embodiments, a method of the present disclosure utilizes a digital filter bank having models of tuned, driven, and damped harmonic resonators. The resonators are modeled via a physical analogy of a damped mass-spring system, with coupling of the resonators in a one-dimensional filter bank. An input signal may be treated as an external force acting on each of the resonators in the filter bank (which may also be referred to as a resonator chain). At any given time, a response of an individual resonator may be interpreted as the spectral coefficient of its resonant frequency. This response may be encoded as amplitude and phase values.

In one embodiment, a computing system maintains state information for the multiple resonator models, each of which has a unique resonant frequency with respect to the others. An iterative process may be performed for multiple respective samples in a set of samples taken in the time domain. The state information is updated for a sample amplitude, and resonator amplitudes and phases are determined for the updated resonator models. Change-in-phase information is also determined, and is stored along with the resonator amplitude for the sample. This information may be used later for resynthesis of the audio signal. Furthermore, information such as a phase increment may be determined, and this information can be used to perform pitch shifting of the audio signal.

As noted above, the time-frequency representation may be generated on a sample-by-sample basis. Based on this time-domain aspect of operation, spectral coefficients for each resonator may be updated with each sample, instead of in windows or blocks of samples. This allows the phase to evolve meaningfully within the samples, rather than in windowed/blocked methods in which various techniques (e.g., overlapping) may be necessitated to avoid artifacts that result from phase discontinuities. The time-coherent phase representation may allow for better fidelity in the representation of audio signals having non-stationary frequency components. For example, a “chirp” sound having a moving frequency may appear as in a representation as a single line having a continuous phase. This may further enhance the ability to detect genuine phase discontinuities in the original audio source.

The discussion below begins with a description of a basic system and method for sampling an audio signal and performing various processing tasks based on the sampled information, using resonator models. An example resonator chain is then discussed, with examples provided for both an excited state as well as an initial (unexcited) state. Various method embodiments utilized in processing the sampled audio signals are then described. A system for resynthesis of an audio signal and automatic generation of a musical composition is then discussed, followed by a description of a device which may implement the various method embodiments discussed herein.

### System and Method for Processing Audio Using Resonator Models:

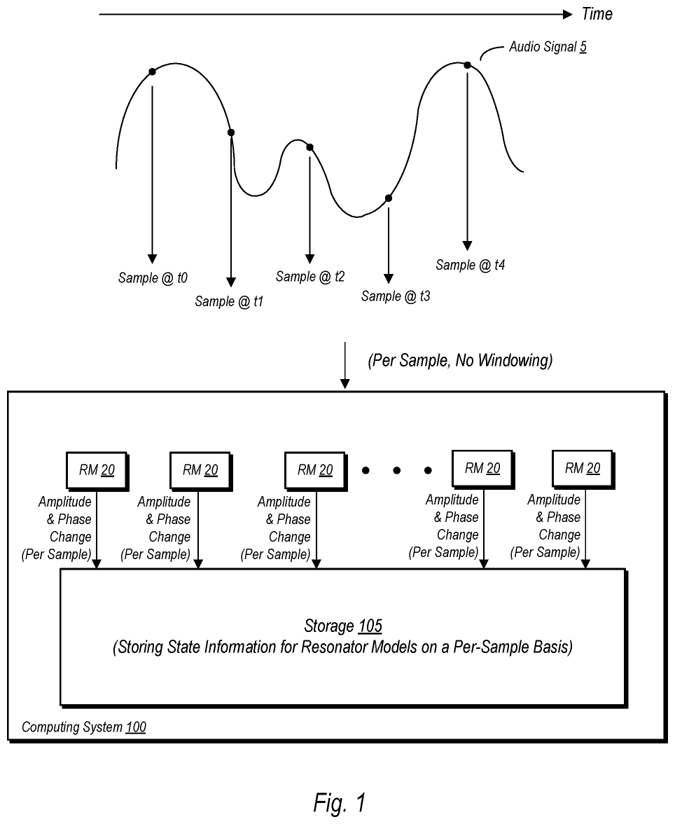

FIG. 1 is a diagram illustrating an example methodology for sampling a signal and updating resonator models according to some embodiments. In the embodiment shown, and audio signal 5 is sampled over time, e.g., at t0, t1, t2, t3, and t4. As these samples are taken, they are provided to computing system 100. A number of resonator models 20 are arranged to receive the samples as they are provided. Each of the resonator models 20 represents a resonator having a different resonant frequency. In terms of frequency, the resonator models 20 may be spaced in any suitable way for receiving audio signals. One way to view the resonator models 20 is as a bank of filters, such as bandpass filters, each of which is most responsive to a particular frequency. Another way to view the resonator models 20 is as models of a physical damped mass-spring system as discussed above

Samples of the audio signal 5 may be generated by conversion from analog into digital using any suitable analog-to-digital converter (ADC, not shown). The digital information for each individual sample is applied to the resonator models 20. Each of the resonator models 20 may, for their respective frequencies, determine amplitude and phase information for the current sample. This information is then stored in storage 105, on a per-sample basis. This is in contrast to various previous methodologies for processing audio data using windows, or blocks of samples instead of individual samples.

The time-frequency representations of audio signal 5 describe the signal in terms of the energy contained in distinct frequency bands as a function of time. This is an alternative to the commonly used time-frequency representation for digital audio known as a Discrete-time Short Time Fourier Transform (DT-STFT). The DT-STFT is a 2-dimensional array of complex numbers representing the amplitude and phase of correlation between the signal and windowed sinusoids of different frequencies through time. Calculation of the DT-STFT involves dividing the input signal into short windows of time, and calculating the FFT of each window (usually multiplied by a windowing function). Corresponding resynthesis methods may divide the signal into overlapping windows, and may further average the frequency response across the overlaps in order to mitigate phase discontinuities that can appear as artifacts of the windowing procedure. This in turn may lead to a loss of phase information. In particular genuine phase discontinuities resulting from transients may be more difficult to detect using the DT-STFT method, and may be less pronounced on resynthesis.

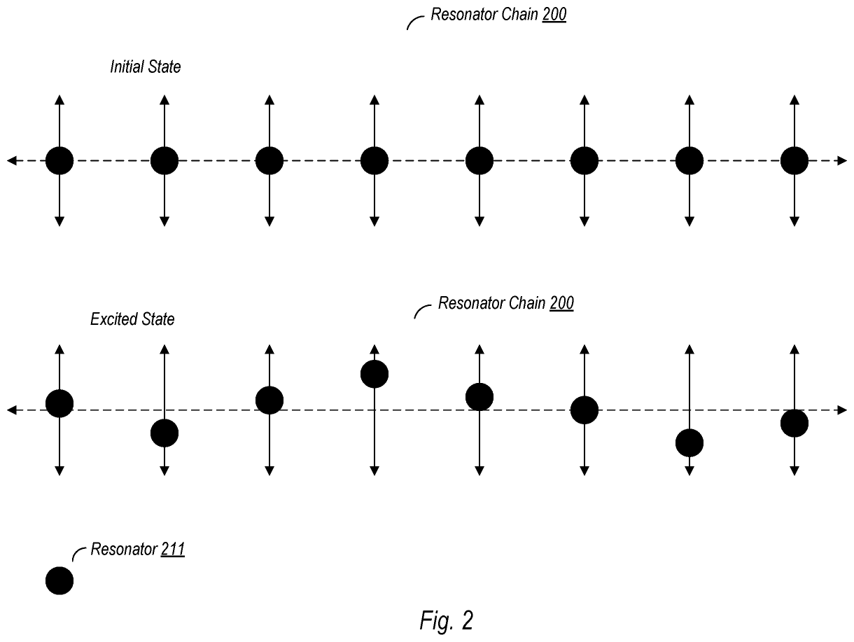

The time-frequency representation disclosed herein and method for calculating the same may be performed without windowing of the audio signal. The representation may comprise amplitudes and unwound phases of a chain of harmonic resonators, which are now discussed in reference to FIG. 2.

FIG. 2 is a diagram illustrating a portion of a resonator chain which is modeled in the various methodologies discussed herein. More particularly, FIG. 2 illustrates resonator chain 200 in an initial (unexcited) state, and in an excited state in response to stimulus from a sampled audio signal. In the initial state, each resonator 211 has no displacement from the horizontal axis. In the excited state, the resonators 211 are displaced in various amounts along a corresponding vertical axis. As noted above, each resonator 211 may represent a digital filter based on an equation of damped simple harmonic motion (e.g., a mass-spring system) in which a mass is displaced vertically and subsequently pulled back to the neutral (unexcited) position by a restorative force.

In a mass-spring system the restorative force is linearly proportional to the displacement, and opposite in sign, as expressed by the equation below:

F=−ky, (Equation 1)

wherein y is the vertical displacement of the resonator and k is the constant factor of the spring in accordance with Hooke's Law. In the absence of external forces the simple harmonic motion equation combines this force law with Newton's second law F=ma to obtain the 2^{nd} order differential equation of motion:

ÿ=−ω²y, (Equation 2)

wherein ÿ is the acceleration, y is the displacement, and ω is the angular frequency of the resultant harmonic motion. The angular frequency can be also be calculated as:

$$ω = \sqrt{\frac{k}{m}} . \qquad ( Equation 3 )$$

When subjected to an external harmonic force, a resonator gains energy and begins to oscillate. The largest response occurs when the external force is varying at the resonant frequency of the resonator. Accordingly, a digital model of this physical process acts as a tuned bandpass filter, where the input signal is treated as an external force, while the output signal is the vertical displacement of the resonator through time. In the absence of damping, the oscillations of the resonator may increase without bound. Accordingly, a damping term is included which is motivated by the physical models and is proportional to the resonator velocity. This modifies the equation of motion to the following:

ÿ=f−c\dot{y}−ω²y, (Equation 4)

where f is the input signal (which may be scaled) and c is a damping constant.

### Methods for Determining Amplitude and Phase on a Sample-by-Sample Basis:

The chain of damped resonators shown in FIG. 2 can be considered as a filter bank of tuned resonators by choosing the constants for each resonator according to frequency bins of interest. Damping may slightly alter the resonant frequency of each resonator, and may also determine the saturation amplitude in response to a particular amplitude of the driving signal. In order to resynthesize the signal with the same frequency equalization as the original, a consideration is given to the different relative saturation amplitudes of the individual resonators. Thus, if Equation 3 is written for the undamped resonant frequency ω₀ and the damping constant is written in terms of a dimensionless scalar multiple η of the resonant frequency, so that the equation of motion becomes:

ÿ=f−(2ηω₀)\dot{y}−(ω²)y. (Equation 5)

Then, for a harmonic driving signal f=F sin(ωt+φ), the maximum amplitude response is obtained at the resonant frequency:

$$ω = \frac{{ω}_{0}}{\sqrt{1 - 2 {η}^{2}}} , \qquad ( Equation 6 )$$

with the corresponding amplitude being:

$$A = \frac{F}{2 m {ω}^{2} η \sqrt{1 - {η}^{2}}} . \qquad ( Equation 7 )$$

The condition for stability is then written as:

$$η \leq \frac{1}{\sqrt{2}} . \qquad ( Equation 8 )$$

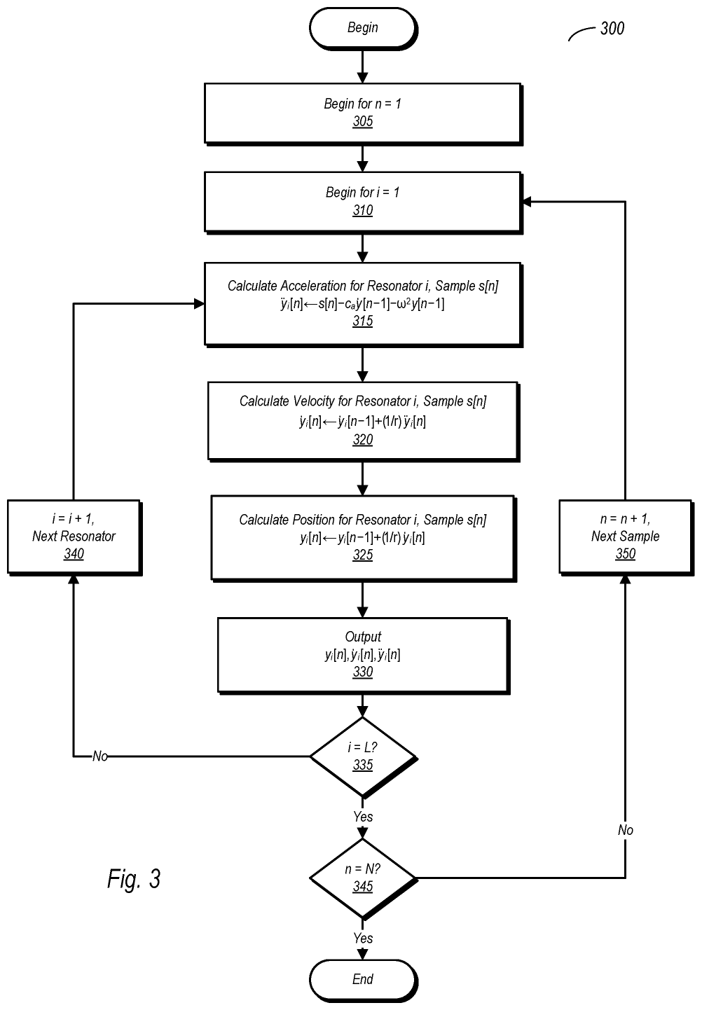

Implementation of this model for a digital input signal requires converting Equation 5 into a difference equation, which can be solved by simple forward iteration. The solving of this difference equation with forward iteration is shown below as Algorithm 1, which is also illustrated in the flow diagram of FIG. 3.

```
Algorithm 1:
Data: s[n] for n = 1 . . . N
Data: yᵢ[0], \dot{y}ᵢ[0], ÿᵢᵢ[0] for i = 0 . . . L
for n = 1 . . . N do
  input: s[n]
  for i = 1 . . . (L − 1) do
    input : yᵢ[n − 1], \dot{y}ᵢ[n − 1], ÿᵢ[n − 1]
  ÿᵢ[n] ← s[n] − cₐ\dot{y} [n − 1] − ω²y[n − 1];
    ${\dot{y}}_{i} [ n ] ← {\dot{y}}_{i} [ n - 1 ] + \frac{1}{r} {\ddot{y}}_{i} [ n ] ;$
    ${y}_{i} [ n ] ← {y}_{i} [ n - 1 ] + \frac{1}{r} {\dot{y}}_{i} [ n ] ;$
    output: yᵢ[n], \dot{y}ᵢ[n], ÿᵢ[n]
    end
end
output: yᵢ[n] for i = 0 . . . L, and n = 0 . . . N
```

Method 300, which implements Algorithm 1 above, begins with Sample[n] where n=1 (block 305) and Resonator i, where i=1 (block 310). The method further includes calculating the acceleration for Resonator i, Sample n, using the illustrated equation using the current sample information along with the velocity and position from the previous sample (block 315). It is noted that the velocity and position values may be zero for the first sample, as there is no previous sample. The value of ω in the illustrated equation corresponds to the resonant (angular) frequency of Resonator i. Next, the velocity for the current sample as applied to Resonator i (block 320) is calculated using the equation shown, with the velocity of the previous sample and the acceleration of the current sample, and an inverse of the sample rate r as operands. Next, using the current velocity and the position of the previous sample, the position for the current sample as applied to Resonator i is calculated (block 325). The resulting output yields the acceleration, velocity, and position of the current sample as applied to that resonator (block 330). If the condition i=L is not true (block 335, no), the value of i is incremented by one (block 340), the method returns to block 415 and the loop repeats for the next resonator. If the condition i=L is true (block 335, yes), but the condition n=N is not true (block 345, no), then the n is incremented by one (block 350) and the method returns to block 310 to be performed on the various resonators for the next sample. If n=N is true (block 345, yes), method 300 is complete.

In some embodiments, updating a given resonator is based at least in part on the state of one or more neighboring resonators. For example, referring back to algorithm 1, some of the calculations may additionally utilize yᵢ₊₁[n], \dot{y}ᵢ₋₂[n−1], or other similar information when updating a given resonator. These values may be adjusted using appropriate weights or constants. This relationship between resonators may improve encoding quality, in some embodiments.

After having determined the position, velocity, and acceleration for the set of resonators for a given sample, a time-frequency representation may be determined. This includes calculating the amplitude and phase for the different resonators of the given sample. Since the resonators may be updated on a sample-by-sample basis, the phase calculation can be unambiguously updated assuming monotonic increase. This leads to a continuously evolving unwound phase (e.g., a continuous curve on a Reimann surface). The points on the surface may be represented as ordered pairs, Γ=(r, φ), where the phase φ is not constrained to [0, 2π], but may take any real number value.

To calculate the updated time frequency coefficients Γ for each new input sample, we calculate the implied instantaneous amplitude and phase of the associated resonator, assuming a relatively slowly evolving amplitude, based on the displacement and velocity terms being 90° out of phase with each other.

Assuming that:

\dot{y}=iωy, (Equation 9)

and where y is considered to be the real part of re^{iφ}, we have:

[symbol]

(re^{iφ})=y (Equation 10)

and:

[symbol]

(iωre^{iφ})=\dot{y}. (Equation 11)

where R refers to the real part of the a complex number. Solving for φ and r yields:

$$\begin{matrix}φ = {tan}^{- 1} ( \frac{- \dot{y}}{ω y} ) , \\ and \text{:} & ( Equation 12 ) \\ r = \frac{y}{cos φ} & ( Equation 13 )\end{matrix}$$

The arctan function (written tan⁻¹ above) is understood as selecting the branch of the multi-valued function that yields the smallest value greater than the previous value for the phase. The total differential of the phase may be expressed via a two-dimensional gradient of arctan considered as a function of

$$\frac{- \dot{y}}{ω} .$$

### Writing w as

$$\frac{\dot{y}}{ω} ,$$

the differential of the phase φ becomes:

$$d φ = \frac{wdy + ydw}{{y}^{2} + {w}^{2}} . \qquad ( Equation 15 )$$

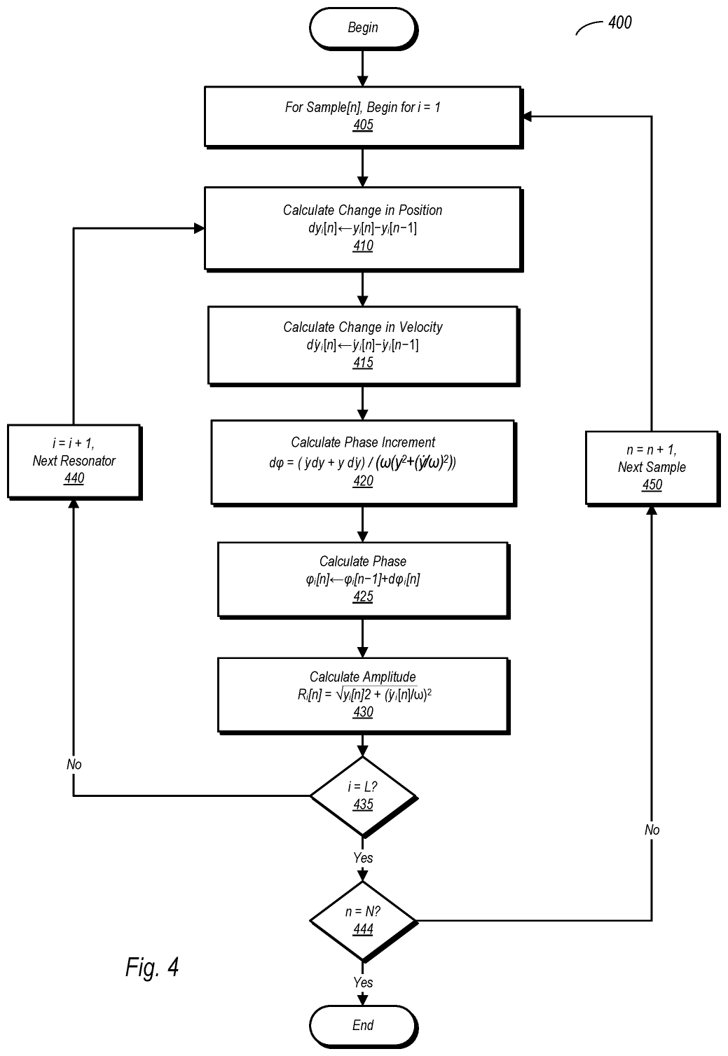

Knowing the equations for amplitude r, phase φ, and a phase differential, these values can be calculated for each sample at each resonator. This is shown in the flow diagram of FIG. 4, and as Algorithm 2, below:

Algorithm 2: Calculation of time-frequency representation

| for i = 0...L do | |
|---|---|
| | input : yᵢ[n], yᵢ[n], rᵢ[n−1], φᵢ[n − 1] |
| | dyᵢ[n] ← yᵢ[n] − yᵢ[n − 1] ; |
| | d\dot{y}ᵢ[n] ← \dot{y}ᵢ[n] − \dot{y}ᵢ[n − 1] ; |
| | dφ[n] ← (\dot{y}dy+yd\dot{y})/ω(y²+(\dot{y}/ω)²); |
| | φᵢ[n] ← φᵢ[n − 1] + dφᵢ[n] ; |
| | rᵢ[n] ← {square root over (yᵢ [n]² + (\dot{y}ᵢ[n])/ω)² ;)} |

end

Output: rᵢ[n], φᵢ[n] for i = 0 ... L and n = 0 ... N

Method 400 begins with, for Sample[n] and Resonator i=1 (block 405). The change in position of the resonator is then calculated using the current position and the position of the previous sample for resonator[n] (block 410). Next, the change in velocity is calculated using the current velocity and the velocity from the previous sample for resonator[n] (block 415). Having the change in position and change in velocity, the phase increment is calculated (block 420). Having the phase increment, the current phase is calculated (block 425), along with a determination of the current amplitude (block 430). If the condition i=L is not true (block 435, no), the value of i is incremented (block 440) and the method returns to block 410 to repeat. If the condition i=L is true (block 435, yes), but the condition n=N is not true (block 445, no), then n is incremented (block 450) and the method returns to block 405 to begin the process for the next sample. If the condition i=L is true (block 435, yes), and the condition n=N is also true (block 445, yes), the method is complete.

The time frequency representation calculated in the manner described above may then be used in a number of applications. Resynthesis of the original signal from this representation is achieved via a form of “phase vocoding”: using an oscillator function for each element of the resonant filter bank, we can use the calculated amplitudes and phases r and φ to drive updates of an oscillator r sin φ. Pitch shifting can readily be achieved by multiplying a constant scaling factor s against the phase increments df in the algorithm above, e.g.,

φᵢ[n]←φᵢ[n−1]+sdφi[n]. (Equation 16)

This may result in a resynthesized signal with oscillatory components changed in pitch, but with the overall speed of playback unchanged. The continuity of the phase and amplitude values may reduce audio artifacts that can arise from traditional FFT based phase vocoders. The continuity of the phase and amplitude values also may also lend itself to synthesizing sounds using interpolated values of this time-frequency representation, for example as might be derived from a Variational Auto Encoder trained on a corpus of signals in this representation.

It is noted that, during processing, the performing of various portions of Methods 300 and 400 may be performed concurrently with one another. For example, all or a portion of the resonator models may be updated in parallel for a given incoming sample and all or a portion of the amplitude and phase differences may be calculated in parallel for all or a portion of the resonator models. It is further noted that various mechanisms are contemplated for carrying out the various methods discussed herein. These methods includes instructions implemented on a non-transitory computer readable medium that may be executed by a processor of a computer system, a field-programmable gate array (FPGA) programmed to carry out these methods, hardwired circuitry, and so on. Generally speaking, the disclosure contemplates a wide variety of suitable mechanisms for carrying out the methods disclosed herein and any number of combinations of hardware and software.

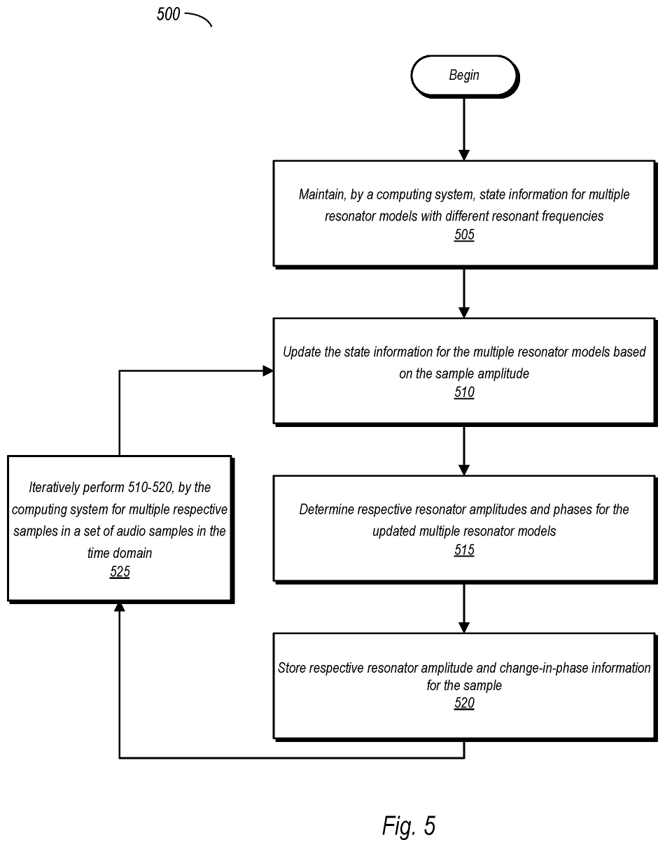

FIG. 5 is a flow diagram of another embodiment of a method that may be carried out in accordance with this disclosure. In accordance with the above, it is noted that the various method steps carried out by Method 500 may, in various embodiments, be performed concurrent with one another, e.g., for multiple samples and/or multiple resonators at a given time.

Method 500 includes maintaining, by a computing system, state information for multiple resonator models with different resonant frequencies (block 505). The method further includes updating the state information for the multiple resonator models based on the sample amplitude (block 510), determining respective resonator amplitudes and phases for the updated multiple resonator models (block 515), and storing, respective resonator amplitude and change-in-phase information for the sample (block 520). The method may be carried out by iteratively performing blocks 510-520, by the computing system for multiple respective samples in a set of audio samples in the time domain (block 525).

In various embodiments, updating the state information for a given one of the multiple resonator models includes determining a current acceleration of the given one of the multiple resonator models.

Updating the state information may also include determining a current velocity of the given one of the multiple resonator models and determining a current position of the given one of the multiple resonator models. In determining these various values, various embodiments of the method may also include determining the current acceleration based on a current sample, a previous velocity, and a previous position for the given one of the multiple resonator models, determining the current velocity based on the previous velocity and the current acceleration for the given one of the multiple resonator models and determining the current position based on the current velocity and the previous position the given one of the multiple resonator models.

Embodiments of the method are further contemplated wherein determining a resonator amplitude and phase for a current sample of a given one of the multiple resonator models of the includes calculating a current phase for the current sample based on a phase of a preceding sample and a phase increment and calculating a current resonator amplitude based on position. In such embodiments, determining the resonator amplitude and phase for the current sample of the given one of the multiple resonator models includes determining a change in position caused by the current sample relative to a position of the preceding sample for the given one of the multiple resonator models and determining a change in velocity caused by the current sample relative to a velocity of the preceding sample for the given one of the multiple resonator models. Thereafter, the method continues with calculating the phase increment based on the change in position and the change in velocity.

Some embodiments of the method include performing the updating and the determining on a per-sample basis without windowing of multiple samples.

Embodiments are further possible and contemplated that include resynthesizing the audio signal comprises providing the stored resonator amplitude and change-in phase information of the updated multiple resonator models to an oscillator function. In these embodiments, resynthesizing the audio signal further includes pitch-shifting ones of the set of audio samples, wherein the pitch shifting comprises shifting respective phases of the ones of the set of the audio samples by a product of a phase increment and a scaling factor.

The present disclosure also contemplates methods that include resynthesizing an audio signal from the stored resonator amplitude and change-in-phase information and automatically combining the audio signal with one or more additional audio signals to form a musical composition.

### Data Structure and System Embodiments:

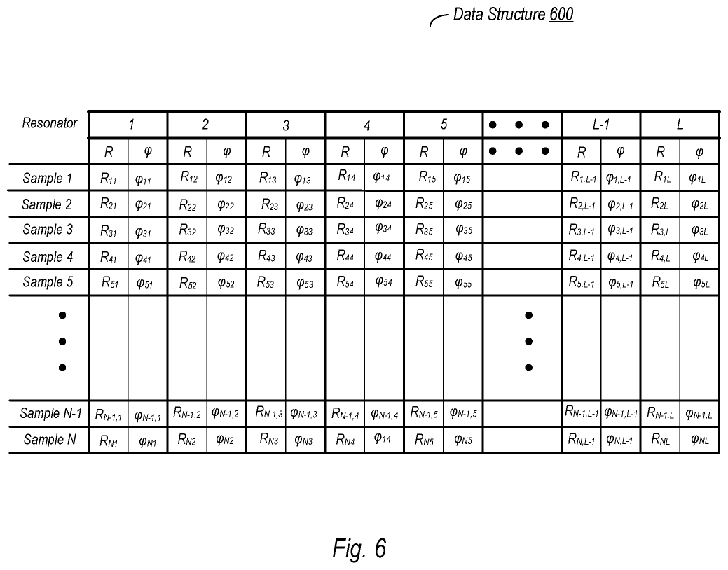

FIG. 6 is a diagram illustrating one embodiment of a data structure that may be generated by a system carrying out the method embodiments discussed above. In the embodiment shown, data structure 600 includes amplitude R and phase-change values φ for a total of L different resonators of a resonator chain as discussed above. Furthermore, as the present disclosure contemplates generating this information on a sample-by-sample basis, without windowing, the data structure includes amplitude R and phase values φ for each of a N different samples for each of the L resonators.

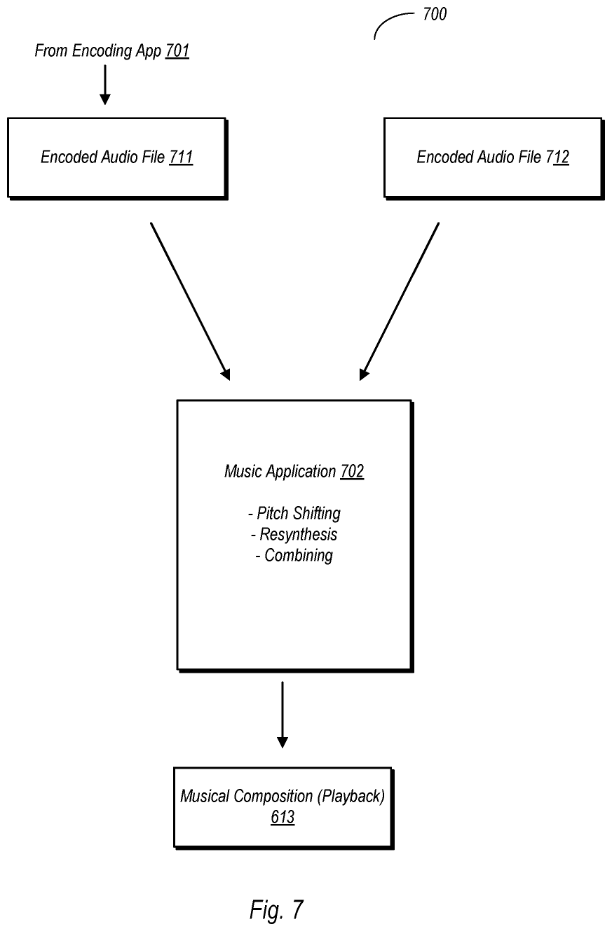

FIG. 7 is a block diagram illustrating one embodiment of a system for generating a musical composition using encoded audio files. As noted above, the various algorithms/methodologies discussed herein may be used in the automatic generation of musical compositions using, e.g., artificial intelligence (AI). In the embodiment shown, system 700 is arranged to receive encoded audio files 711 and 712, which the former being received from an encoding application 701 arranged to carry out embodiments of the algorithms/methods discussed above. It is noted that audio filed 712 may be encoded in the same manner (using encoding application 701) as audio file 711. However, it is not required that all audio files in system 700 be encoded in this particular manner.

The encoded audio files 711 and 712 are provided to a music application 702. Among the different operations that may be carried out in the music application are combining, resynthesis, and pitch shifting as discussed above, in which a phase increment or differential is multiplied by some scaling factor to shift the pitch of the various audio signals to be generated from the audio files. For example, the audio files 711 and 712 may both include various musical arrangements that, if the original pitch is maintained, would result in one arrangement not being in a compatible musical key with the other. Accordingly using, e.g., the various AI that may be implemented in musical application 702, audio file 711 may be pitch-shifted to a musical key that is compatible with that of audio file 712.

After performing any desired pitch shifting, combining, and resynthesizing, the resultant musical composition 613 may be played back. For example, the playback may be conducted on the speaker of a smart phone, computer speakers, or any other device that may utilize music application 702.

In one embodiment, the operations discussed above with reference to FIGS. 1-6 and incorporated into encoding application 701 may be performed separately from musical application 702. However, embodiments are also possible and contemplated in which encoding application 701 is incorporated into a common application with music application 702.

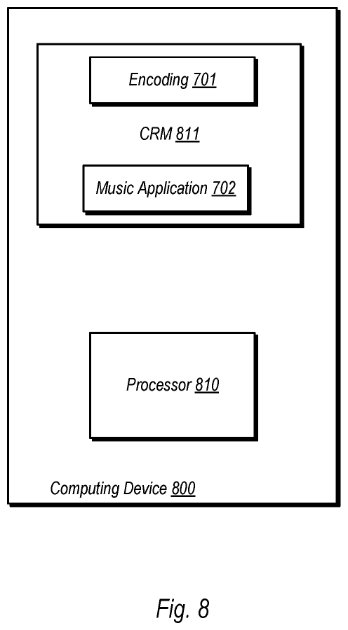

FIG. 8 is a block diagram of one embodiment of a computing device that may be used to carry out the various operations discussed above. In the embodiment shown computing device 800 includes a non-transitory computer readable medium (CRM) 811 upon which is stored an embodiment of encoding application 701 and music application 702. CRM 811 may be implemented using any suitable mechanism for persistent storage, such as flash memory, disk storage, random access memory (RAM), static random access memory (SRAM), and so on.

Processor 810 of computing device 800 is configured to execute the instructions of encoding application 701 and music application 702, using suitable input data. This may include audio files. Computing device 800 may also be configured to sample analog audio signals and generate the corresponding audio files based thereon.

Computing device 800 may be one of a number of different types of computers. For example, computing device 800 may be a smart phone, a desktop computer, a laptop computer, and so on. Generally speaking, computing device 800 may be any type of computing device capable of carrying out the various methods discussed above to encode audio file, perform pitch shifting, resynthesize audio files, combine audio files, and automatically generate a musical composition using the audio files.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity, described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed. FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Numerous variations and modifications will become apparent to those skilled in the art once the above disclosure is fully appreciated. It is intended that the following claims be interpreted to embrace all such variations and modifications.

What is claimed is:

1. A method comprising:
maintaining, by a computing system, state information for multiple resonator models with different resonant frequencies;
iteratively performing, by the computing system for multiple respective samples in a set of audio samples in a time domain:
updating the state information for the multiple resonator models based on a sample amplitude;
determining respective resonator amplitudes and phases for the updated multiple resonator models; and
storing, respective resonator amplitude and change-in-phase information for the sample.

2. The method of claim 1, wherein updating the state information for a given one of the multiple resonator models comprises:
determining a current acceleration of the given one of the multiple resonator models;
determining a current velocity of the given one of the multiple resonator models; and
determining a current position of the given one of the multiple resonator models.

3. The method of claim 2, further comprising:
determining the current acceleration based on a current sample, a previous velocity, and a previous position for the given one of the multiple resonator models;
determining the current velocity based on the previous velocity and the current acceleration for the given one of the multiple resonator models; and
determining the current position based on the current velocity and the previous position the given one of the multiple resonator models.

4. The method of claim 1, wherein determining a resonator amplitude and phase for a current sample of a given one of the multiple resonator models of the comprises:
calculating a current phase for the current sample based on a phase of a preceding sample and a phase increment; and
calculating a current resonator amplitude based on position.

5. The method of claim 4, wherein determining the resonator amplitude and phase for the current sample of the given one of the multiple resonator models further comprises:
determining a change in position caused by the current sample relative to a position of the preceding sample for the given one of the multiple resonator models;
determining a change in velocity caused by the current sample relative to a velocity of the preceding sample for the given one of the multiple resonator models; and
calculating the phase increment based on the change in position and the change in velocity.

6. The method of claim 1, further comprising performing the updating and the determining on a per-sample basis without windowing of multiple samples.

7. The method of claim 1, further comprising resynthesizing an audio signal, wherein resynthesizing the audio signal comprises providing the stored resonator amplitude and change-in phase information of the updated multiple resonator models to an oscillator function.

8. The method of claim 7, wherein resynthesizing the audio signal further comprises:
pitch-shifting ones of the set of audio samples, wherein the pitch shifting comprises shifting respective phases of the ones of the set of the audio samples by a product of a phase increment and a scaling factor.

9. The method of claim 1, further comprising:
resynthesizing an audio signal from the stored resonator amplitude and change-in-phase information; and
automatically combining the audio signal with one or more additional audio signals to form a musical composition.

10. A non-transitory computer readable medium storing instructions that, when executed by a processor, perform operations comprising:
generating multiple respective audio samples in a time domain;
updating state information for multiple resonator models based on a sample amplitude for ones of the multiple audio samples, the multiple resonator models having different resonant frequencies with respect to one another;
determining respective resonator amplitudes and phases for the updated multiple resonator models for the ones of the multiple audio samples; and
storing, respective resonator amplitude and phase shift information, per resonator model, for the ones of the multiple samples.

11. The computer readable medium of claim 10, wherein the operations further comprise resynthesizing an audio signal using the multiple audio samples, wherein resynthesizing the audio signal comprises:
providing the amplitudes and the phase shifts of the updated multiple resonator models to an oscillator function; and
pitch shifting ones of the multiple audio samples, wherein pitch shifting the ones of the multiple audio samples comprises applying a product of a phase increment and a scaling factor to the phases of the multiple resonator models.

12. The computer readable medium of claim 10, wherein updating a given resonator is based at least in part on a state of one or more neighboring resonators.

13. The computer readable medium of claim 12, wherein the operations further comprise automatically generating a musical composition using the resynthesized audio signal and one or more additional audio signals.

14. The computer readable medium of claim 10, wherein updating state information for a given one of the multiple resonator models includes:
calculating a current acceleration of the given one of the multiple resonator models based on a previous velocity and a previous position for the given one of the multiple resonator models;
calculating a current velocity of the given one of the multiple resonator models based on the previous velocity and the current acceleration for the given one of the multiple resonator models; and
calculating a current position of the given one of the multiple resonator models based on the previous velocity and the current acceleration for the given one of the multiple resonator models.

15. The computer readable medium of claim 10, determining resonator amplitudes and phases for a given one of the multiple resonator models comprises:
determining a change in position and a change of velocity for the current sample relative to a preceding sample for the given one of the multiple resonator models;
calculating a phase increment for the current sample based on the change in position and the change of velocity;
calculating a current phase for the current sample based on a phase of a preceding sample and the phase increment; and
calculating a current resonator amplitude based on a position of the current sample.

16. The computer readable medium of claim 10, wherein the operations further comprise performing the updating, the determining, and the storing on a per-sample basis without windowing.

17. An apparatus comprising:
a processor;
a non-transitory computer readable medium storing instructions that, when executed by the processor, perform operations comprising:
maintaining state information for multiple resonator models having different resonant frequencies with respect to one another;
perform, on a sample-by-sample basis for multiple respective audio samples in a set of audio samples in a time domain, operations that include:
updating the state information for the multiple resonator models based on an amplitude of a current sample;
determining respective resonator amplitudes and phases for the updated multiple resonator models; and
storing, respective resonator amplitude and phase shift information, per resonator model, for the current sample.

18. The apparatus of claim 17, wherein the operations further include:
resynthesizing an audio signal by providing the amplitudes and the phase shift of the updated multiple resonator models to an oscillator function, and wherein resynthesizing the audio signal further comprises pitch-shifting ones of the audio samples of the set of audio samples by applying a product of a phase increment and a scaling factor to the audio samples;
automatically generating a musical composition using the audio signal and at least one additional audio signal; and
performing playback of the musical composition through a speaker of the apparatus.

19. The apparatus of claim 17, wherein the computer readable medium stores instructions that, when executed by the processor, perform operations comprising:
calculating a current acceleration of a given one of the multiple resonator models based on a previous velocity and a previous position for the given one of the multiple resonator models;
calculating a current velocity of the given one of the multiple resonator models based on the previous velocity and the current acceleration for the given one of the multiple resonator models; and
calculating a current position of the given one of the multiple resonator models based on the previous velocity and the current acceleration for the given one of the multiple resonator models.

20. The apparatus of claim 17, wherein the computer readable medium stores instructions that, when executed by the processor, perform operations comprising:
determining a change in position and a change of velocity for the current sample relative to a preceding sample for a given one of the multiple resonator models;
calculating a phase increment for the current sample based on the change in position and the change of velocity;
calculating a current phase for the current sample based on a phase of a preceding sample and the phase increment; and
calculating a current resonator amplitude based on a position of the current sample.
